(19) United States
(12) Patent Application Publication
(10) Pub. No.: US 2014/0077944 A1
(43) Pub. Date: Mar. 20, 2014

(54) PERSONAL AREA MAPPING

(71) Applicants: Lonny BASKIN, Tsur Hadassah (IL); Ariel Malamud, Jerusalem (IL)

(72) Inventors: Lonny BASKIN, Tsur Hadassah (IL); Ariel Malamud, Jerusalem (IL)

(21) Appl. No.: 13/621,483

(22) Filed: Sep. 17, 2012

(51) Int. Cl. G08C 17/02

(52) U.S. Cl. CPC G08C 17/02
USPC 340/539.1

(57) ABSTRACT

Systems and apparatuses are directed to wireless tag elements each having unique first identifier information and attached to objects to be tracked and wireless sensors arranged to provide corresponding zones of coverage that collectively define an area mapping the location of the objects to be tracked. Each wireless sensor having unique second identifier information and wirelessly transmitting a scanning signal that detects presence of the wireless tag elements, reads the first identifier information of the detected wireless tag elements, and wirelessly transmits the first identifier information along with its second identifier information. A controller wirelessly communicates with the wireless sensors to receive the first and second identifier information. Logic then correlates the second identifier information with first identifier information to determine which zones the detected tag elements are located, and then provides area mapping information indicating the location of the objects within the zones of coverage.

### TECHNICAL FIELD

This disclosure relates generally to the field of wireless communications, and in particular, to wireless device location identification.

### BACKGROUND ART

Conventional location techniques rely on established technologies, such as, global positioning/navigation satellite systems (GPS/GNSS). However, GPS/GNSS technologies are not suitable for indoor applications, as microwave signals are susceptible to attenuation and scattering issues due to physical obstructions (e.g., roofs, walls, metal infrastructure, etc.). In addition, GPS/GNSS technologies depend on a complex network infrastructure with expensive operating costs.

Various attempts have been made to develop indoor positioning/location systems that map a wireless-enabled device to a particular indoor area, e.g., a room, a shopping mall, etc. Typically, such indoor positioning/location systems have been based on Wi-Fi networks, employing Wi-Fi controllers and multiple network access points for location awareness. However, these indoor positioning systems are not without accuracy and reliability issues and, like GPS/GNSS technologies, they also depend on a complex network infrastructure.

### BRIEF DESCRIPTION OF THE DRAWINGS

FIG. 1A depicts a functional block diagram of a personal area mapping system, in accordance with various aspects and principles of the present disclosure.

FIG. 18 depicts a functional block diagram of an alternative personal area mapping system, in accordance with various aspects and principles of the present disclosure.

FIG. 2 depicts a functional block diagram of a personal area mapping controller, in accordance with various aspects and principles of the present disclosure.

### DETAILED DESCRIPTION

In the description that follows, like components have been given the same reference numerals, regardless of whether they are shown in different embodiments. To illustrate an embodiment(s) of the present disclosure in a clear and concise manner, the drawings may not necessarily be to scale and certain features may be shown in somewhat schematic form. Features that are described and/or illustrated with respect to one embodiment may be used in the same way or in a similar way in one or more other embodiments and/or in combination with or instead of the features of the other embodiments.

In accordance with various embodiments of this disclosure, what is proposed is a personal area mapping system that includes wireless tag elements each having unique first identifier information and attached to objects to be tracked and wireless sensors arranged to provide corresponding zones of coverage that collectively define an area mapping the location of the objects to be tracked. Each wireless sensor having unique second identifier information and wirelessly transmitting a scanning signal that detects presence of the wireless tag elements, reads the first identifier information of the detected wireless tag elements, and wirelessly transmits the first identifier information along with its second identifier information. A controller wirelessly communicates with the wireless sensors to receive the first and second identifier information. Logic then correlates the second identifier information with first identifier information to determine which zones the detected tag elements are located, and then provides area mapping information indicating the location of the objects within the zones of coverage.

In another embodiment, an apparatus is presented that includes a controller configured to receive first identifier information indicative of detected tag elements individually attached to objects to be tracked, the first identifier information being unique to each of the tag elements, and to receive second identifier information indicative of wireless sensors that wirelessly detect the tag elements, the second identifier information being unique to each of the wireless sensors, the wireless sensors physically arranged to provide corresponding zones of coverage that collectively define an area mapping the location of the objects to be tracked. Logic then correlates the received second identifier information with received first identifier information to determine which zones of coverage each of the detected tag elements are located, and provides area mapping information indicating the location of the objects based on the location of the detected tag elements within the zones of coverage.

These and other features and characteristics, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of claims. As used in the specification and in the claims, the singular form of “a”, “an”, and “the” include plural referents unless the context clearly dictates otherwise.

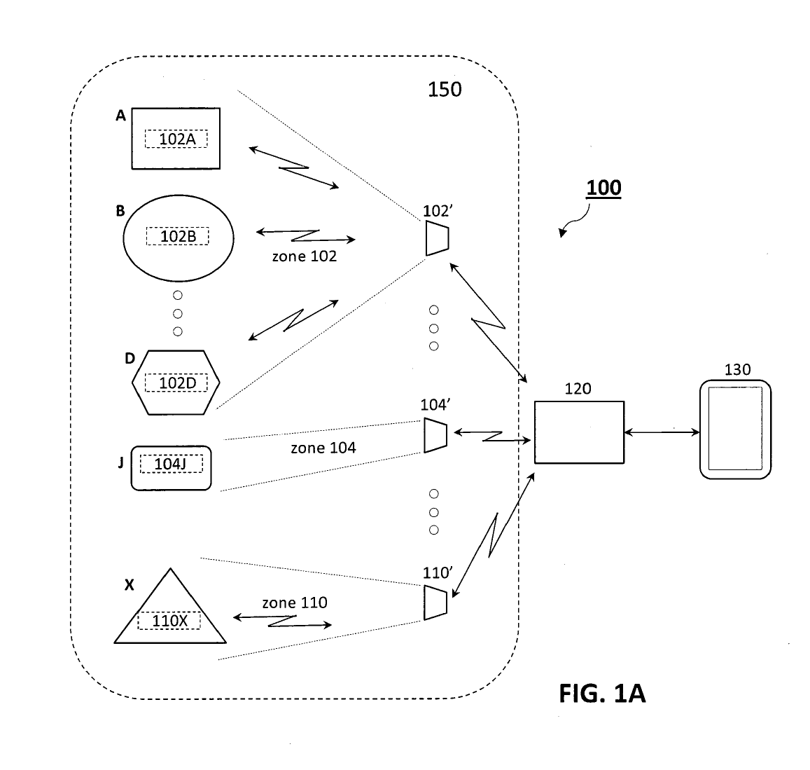

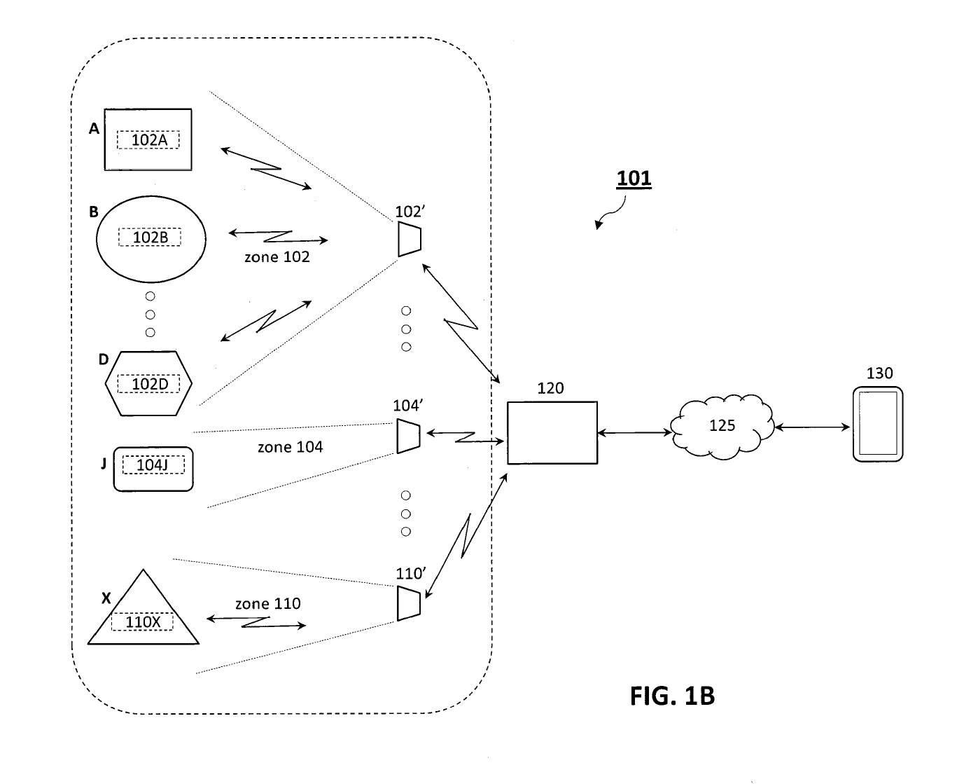

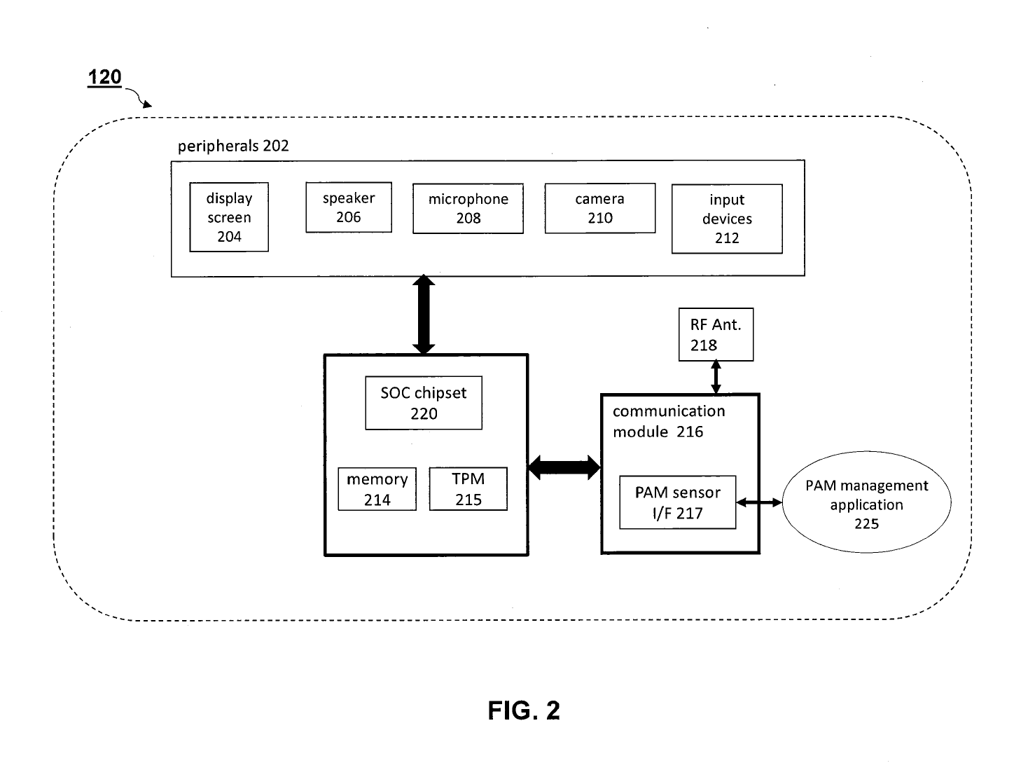

The disclosed embodiments are generally directed to a low-cost, low-power, and flexible personal area mapping (PAM) system and method that are capable of locating/tracking objects within a personal area. The personal area may be indoors or outdoors, a home, office, backyard, vehicle, or any area designated by a user as a familiar space and may comprise one or more zones. In particular, FIG. 1A depicts a non-limiting example of PAM system 100, in accordance with various aspects and principles of the present disclosure. PAM system 100 includes wireless tag elements (i.e., tags) 102A-102D, 104J, and 110X that are placed on, coupled, or attached to objects to be tracked A-D, J, and X within personal area 150.

PAM system 100 also includes wireless sensors 102′, 104′, and 110′ that are configured to wirelessly detect the presence of tags 102A-102D, 104J, and 110X and, thus, the location of objects A-D, J, and X. Wireless sensors 102′, 104′, and 110′ wirelessly communicate or report the location information of tags 102A-102D, 104J, and 110X to PAM controller 120. In turn, PAM controller 120 processes the information to map and track objects A-D, J, and X and present the information to user device 130.

By way of example, objects to be tracked A-D, J, and X may be personal items ranging from phones, remote controls, keys, passports, and wallets to clothing, notebooks, and dog leashes—and even persons of interest, such as, minor children, elderly persons, persons with certain disabilities, etc.

Tags 102A-102D, 104J, and 110X may comprise an antenna for transmitting and receiving a radiofrequency signal and a microchip or other suitable electro-magnetic device/circuitry capable of electronically storing unique identification information in non-volatile memory as well as for processing information and modulating/demodulating the radiofrequency signal. The unique identification information may be supplied to, or read by, wireless sensors 102′, 104′, and 110′ in response to scanning radiofrequency signals transmitted by wireless sensors 102′, 104′, and 110′.

Tags 102A-102D, 104J, and 110X may be passive devices that lack their own power source and are energized by being inductively coupled to a magnetic field generated by a radiofrequency signal, such as the scanning radiofrequency signals transmitted by wireless sensors 102′, 104′, and 110′. Alternatively or in addition to, tags 102A-102D, 104J, and 110X may be configured as active devices with self-contained energy sources (e.g., batteries) and may be also capable of generating their own radiofrequency signals. Regardless of whether tags 102A-102D, 104J, and 110X are passive or active devices, it is preferable for the tags to be inconspicuous in size and take the form of a sticker, bracelet, wristband, label, card, printed stamp, key fob, pin, or other suitable media that may be easily attached or coupled to objects A-D, J, and X. For example, a tag key fob may be easily attached to a key ring, a tag bracelet may be worn by minor children or the elderly, and a tag sticker may be attached to an article of clothing.

Wireless sensors 102′, 104′, and 110′ comprise low power transceiver sensors that operate to wirelessly transmit radiofrequency signals configured to scan and detect the presence of tags 102A-102D, 104J, and 110X within a certain zone of coverage. To perform scanning operations, wireless sensors 102′, 104′, and 110′ may transmit encoded scanning radiofrequency signals that detect the presence of tags 102A-102D, 104J, and 110X and read the identification information of store therein. Alternatively, or in addition to, the scanning operation may comprise the transmission of radiofrequency signals with interrogation messages/commands by wireless sensors 102′, 104′, and 110′ in which tags 102A-102D, 104J, and 110X respond with their identification information.

Moreover, wireless sensors 102′, 104′, and 110′ may perform their scanning operations, either by reading tags 102A-102D, 104J, and 110X or by interrogating tags 102A-102D, 104J, and 110X, based on a periodic, polling basis. Alternatively, or in addition to, wireless sensors 102′, 104′, and 110′ may perform their scanning operations based on commands or instructions provided by PAM controller 120.

As such, wireless sensors 102′, 104′, and 110′ may include transceivers, transponders, modulation/demodulation, and/or memory circuitry as well as an antenna. Such circuitry may be configured with operational communication characteristics, such as radiofrequencies, distance ranges, data rates, encoding formats, duty cycles, etc. in accordance with bidirectional, low power communication protocols/standards, such as, for example, Bluetooth low energy (BLE), low power WiFi, Zigbee, Z-Wave, RFID, etc.

In some embodiments, personal area 150 may be divided into zones 102, 104, 110 that are defined by the placement and zonal coverage of wireless sensors 102′, 104′, and 110′, as illustrated in FIG. 1A. Wireless sensors 102′, 104′, and 110′ are intended to be placed on fixed or stationary locations, such as, for example, walls, ceilings, door jambs, large furniture, porches, decks, windshields, rear view mirrors, etc. Preferably, although not required, wireless sensors 102′, 104′, and 110′ are battery powered for convenience as well as facilitating inconspicuous placement.

Returning to FIG. 1A, each of wireless sensors 102′, 104′, and 110′ are also configured to wirelessly communicate and report the location information of tags 102A-102D, 104J, and 110X as well as their own identification information to PAM controller 120. Such wireless communication may, again, be performed in accordance with low power bidirectional communication protocols/standards, such as, for example, Bluetooth low energy (BLE), low power WiFi, Zigbee, Z-Wave, RFID, etc., as noted above.

PAM controller 120 is configured to wirelessly receive the location information of tags 102A-102D, 104J, and 110X reported by wireless sensors 102′, 104′, identification information of wireless sensors 102′, 104′, and 110′ as well as transmit messages/commands to wireless sensors 102′, 104′, and 110′. PAM controller 120 may comprise a dedicated, special purpose computing device or may equally comprise a desktop, laptop, mobile device, smart phone, gaming device, tablet/notebook computer, personal digital assistant, etc.

FIG. 2 depicts a functional block diagram of PAM controller 120, in accordance with various aspects and principles of the present disclosure. In the depicted embodiment, PAM controller 120 includes a variety of user-interactive peripheral elements, such as, for example, display screen 204, speaker 206, microphone 208, camera 210, input devices 212, as well as processing and communication-related components, such as, memory 214, communication module 216, RF antenna 218, and a system-on-chip (SoC) chipset 220. PAM controller 120 may also include a Trusted Platform Module (TPM) chipset 215 as well as a bus infrastructure and/or other interconnection circuitry to connect and communicate information between the various components of PAM controller 120.

In some embodiments, SoC 220 may be part of a core processing or computing unit of PAM controller 120, and is configured to receive and process input data and instructions, provide output and/or control other components of PAM 120 in accordance with embodiments of the present disclosure. SoC 220 may include a microprocessor, a memory controller, a memory and other components. The microprocessor may further include a cache memory (e.g., SRAM), which along with the memory of SoC 220 may be part of a memory hierarchy to store instructions and data. The microprocessor may also include one or more logic modules such as a field programmable gate array (FPGA) or other logic array. Communication between the SoC 220's microprocessor and memory may be facilitated by the memory controller (or chipset), which may also facilitate communication with peripheral components 202.

Trusted Platform Module (TPM) chipset 215 comprises a security device that stores computer-generated keys for encryption. It is a hardware-based solution intended to prevent the hacking of key entries, passwords, encryption keys, and other sensitive data. TPM chipset 215 may comprise core root of trust measurement (CRTM) module, encryptor module, decryptor module, key generator, a random number generator (RNG), hash engine, platform configuration registers (PCRs), and a secure memory unit. In one embodiment, the TPM chipset 215 is coupled to associated processors, via the bus infrastructure, or may alternatively be integrated into SoC 220.

Memory 214 of PAM controller 120 may be a dynamic storage device coupled to the bus infrastructure and configured to store information, instructions, and programs, such as PAM management application 225, to be executed by processors of SoC 220 and/or other processors (or controllers) associated with PAM controller 120. Some of all of memory 214 may be implemented as Dual In-line Memory Modules (DIMMs), and may be one or more of the following types of memory: Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDECSRAM, PCIOO SDRAM, Double Data Rate SDRAM (DDR SDRAM), Enhanced SDRAM (ESDRAM), SyncLink DRAM (SLDRAM), Direct Rambus DRAM (DRDRAM), Ferroelectric RAM (FRAM), or any other type of memory device. PAM controller 120 may also include read only memory (ROM) and/or other static storage devices coupled to the bus infrastructure and configured to store static information and instructions for processors of SoC 220 and/or other processors (or controllers) associated with PAM controller 120.

Communication module 216 of PAM controller 120 includes PAM sensor interface 217 which comprises transceiver, transponder, modulation/demodulation, and/or memory circuitry. PAM sensor interface 217 is configured to wirelessly transmit information and/or commands to wireless sensors 102′, 104′, and 110′ through radiofrequency signals via RF antenna 218. Conversely, PAM sensor interface 217 is also configured to wirelessly receive the reported tag location information and identification information of wireless sensors 102′, 104′, and 110′ through radiofrequency signals via RF antenna 218. As noted above, the wireless communication between PAM controller 120, via communication module 216, and wireless sensors 102′, 104′, and 110′ may be performed in accordance with low power bidirectional communication protocols/standards, such as, for example, Bluetooth low energy (BLE), low power WiFi, Zigbee, Z-Wave, RFID, etc.

Communication module 216 of PAM controller 120 may also be configured to wirelessly communicate with user device 130. In so doing, such wireless communications may also be performed in accordance with low power bidirectional communication protocols/standards, such as, for example, Bluetooth low energy (BLE), low power WiFi, Zigbee, Z-Wave, RFID, etc. Alternatively or in addition to, such communications may be performed based on one or more standards and protocols including, but not limited to, Ethernet, Wi-Fi, Wi-Gi, Bluetooth, GSM, CDMA, GPRS, 3G or 4G (e.g., WiMAX, LTE) cellular standards, Wireless USB, satellite communication, etc.

PAM sensor interface 217 also communicates relevant information to PAM management application/logic 225. In various embodiments, PAM management application 225 is designed to facilitate the control, mapping, and tracking of object locations as well as the conveyance of such information to user device 130 via the communications noted above. To this end, PAM management application 225 may be configured to provide commands to initiate scanning operations by wireless sensors 102′, 104′, and 110′ based on the lapsing of a polling cycle or through user inputted requests.

Moreover, PAM management application 225 is designed to receive the reported location information of tags 102A-102D, 104J, and 110X and identification information of sensors 102′, 104′, and 110′ from PAM sensor interface 217. Armed with such information, PAM management application 225 may be configured to associate or correlate the received tag location-related information with the identification information of the corresponding sensor reporting the tag location information. In this manner, PAM management application 225 may provide a map of the location of tags 102A-102D, 104J, and 110X based on the zones defined by the reporting sensors 102′, 104′, and 110′.

In addition, PAM management application 225 may format and present the information in a user-friendly manner. For example, PAM management application 225 may provide a virtual or graphical layout of personal area 150 displaying the location of objects A-D, J, and X and/or tags 102A-102D, 104J, and 110X within the zones. Such virtual presentation may depict that the tagged user wallet is in the bedroom, the tagged car keys are in the garage, while the dog leash is in the back yard.

In some embodiments, PAM management application 225 may also be configured to manage the tracking of tagged objects. That is, PAM management application 225 may be configured to determine the differences in location between previously reported tag location information and recent or current reported tag location information, thereby indicating that the object has moved from one zone location to another within personal area 150. For example, if someone moves tagged object A from zone location 102 to zone location 110, sensor 110′ corresponding to the new zone location 110 will report the presence of object A, while sensor 102′ corresponding to the prior zone location 102′ will no longer report the presence of object A. PAM management application 225 may then determine the differences in location information and provide a “movement” alert message to user device 130 notifying the user that object A has moved from zone location 102 to zone location 110 during a certain time interval.

Alternatively or in addition to, PAM management application 225 may be further configured to provide “reminder” alert messages notifying the user that a tagged object should be moved or retrieved by the user within a predetermined time interval. In particular, PAM management application 225 may enable the user to provision the movement of tagged objects at predetermined times/dates, and as the time/date approaches, application 225 may forward a “reminder” alert message to user device 130 notifying the user that the tagged object should be moved or retrieved within a preselected time interval (e.g., 5 minutes, 15 minutes, etc.).

PAM management application 225 may also be further configured to provide “forgotten” alert messages notifying the user that a tagged object was not moved or retrieved after the lapsing of a predetermined time limit. Along similar lines, if the predetermined time/date has lapsed and PAM management application 225 has determined that the tagged object has not moved from its previous zone, application 225 may forward a “forgotten” alert message to user device 130 notifying the user that the tagged object has not been retrieved or moved within the predetermined time limit.

By way of illustration, suppose user has previously inputted to PAM management application 225 that tagged object A (e.g., wallet) in zone 102 (e.g., bedroom) and tagged object D (e.g., car keys) in zone 104 (e.g., garage) are to be moved from their respective locations to zone 110 (e.g., automobile) by a certain time and day (e.g., 8:15 AM on Mondays-Thursdays). In this scenario, after receiving reports from wireless sensors 102′ and 110′ that the tagged wallet still remains in zone 102 (e.g., bedroom) and the tagged car keys remain in zone 104 (e.g., garage), PAM management application 225 forwards a “reminder” alert message to user device 130 at 8:00 AM on Tuesday, notifying the user that the tagged objects should be retrieved within 15 minutes.

In response to the “reminder” alert message, further suppose that user has duly retrieved both the tagged car keys and tagged wallet from their respective zones (e.g., zone 102, bedroom; and zone 104, garage key holder) but the tagged wallet is dislodged from the user's person (i.e., falls out of user's pocket onto garage floor). In this scenario, PAM management application 225 receives reports from corresponding sensors 102′, 104′, and 110′ and determines that tagged object D (e.g., car keys) has been moved from zone 104 (e.g., garage) to zone 110 (e.g., automobile) while tagged object A (e.g., wallet) is now in zone 104 (e.g., garage). PAM management application 225 will then forward a “forgot” alert message to user device 130, at 8:16 AM on Tuesday, notifying the user that the tagged wallet has not been moved to desired zone 110 (e.g., automobile) and is in currently in zone 104 (e.g., garage).

It will be appreciated that the access and communications between wireless sensors 102′, 104′, and 110′ to PAM controller 120 and to user device 130 may be secure to ensure privacy and prevent unauthorized eavesdropping or sensing of the tags and sensors. As such, PAM management application 225 may perform certain functionality, such as, for example granting access based on PIN codes or other personal user information, verifying data integrity, performing virus scans, scanning for malware, comparing security hashes, verifying sources, verifying digital signatures, authenticating users, verifying user information, etc. In some embodiments, confidential or sensitive information, including PIN codes and user information, may be protected by the Trusted Platform Module (TPM) chipset 215, which reads the sensitive information and stores it in a protected memory region.

It will be further appreciated that the capabilities of PAM management application 225 are not limited by the disclosed examples and embodiments presented herein, as artisans of ordinary skill readily appreciate that the PAM management application 225 may be configured to analyze, correlate, process, and apply the reported tag location-related information in a variety of ways to provide useful location information to the user.

Moreover, although FIG. 1A depicts PAM controller 120 as being separate and independent from user device 130, it will be appreciated that in certain embodiments, the functionality of PAM controller 120 may be substituted with, integrated with, or transferred to, user device 130. Such embodiments may occur, for example, when user device 130 includes some or all of the PAM controller 120 elements noted above, including a communication interface configured to communicate with wireless sensors 102′, 104′, and 110′.

As discussed above in system 100, PAM controller 120 processes the information to map and track the tagged objects and present the tag location-related information to user device 130. In some embodiments, however, it may be beneficial for PAM controller 120 to first present the reported tag location-related information to a trusted, third party, cloud service provider 125, which may then process, format, and present such information to user device 130, as depicted by FIG. 1B. In so doing, PAM controller 120 and PAM management application 225 may be simplified to provide a subset or portion of the functionality described above, as cloud service provider 125 would provide necessary operations, in accordance with the arrangements and policies agreed to between cloud service provider 125 and user.

To this end, FIG. 1B depicts a non-limiting example of PAM system 101, in accordance with various aspects and principles of the present disclosure. PAM system 101 incorporates cloud service provider 125 that receives the raw tag location-related information from PAM controller 120, namely, the reported location information of tags 102A-102D, 104J, and 110X as well as the wireless sensors 102′, 104′, and 110′ identification information.

In turn, cloud service provider 125 may be configured to associate the received tag location-related information with the identification information of the corresponding sensor reporting the tag location information. In this manner, cloud service provider 125 may provide a map of the location of tags 102A-102D, 104J, and 110X based on the zones defined by the reporting sensors 102′, 104′, and 110′.

Cloud service provider 125 may also format and present the tag location-related information in a user-friendly manner. For example, cloud service provider 125 may provide a virtual or graphical layout of personal area 150 displaying the location of objects A-D, J, and X and/or tags 102A-102D, 104J, and 110X within the zones.

Cloud service provider 125 may “push” tag location-related and alert messages to user device 130 at regular intervals or on an event-triggered basis. In addition, cloud service provider 125 may respond to user-initiated requests. It will be appreciated that user initiated access and communication with cloud service provider 125 may be achieved through an associated Uniform Resource Locator (URL) link and connection to the online portal/electronic information resource interface of cloud service provider 125, such as, for example, a web-page, desktop application, mobile application, etc.

It will further be appreciated that the access and communications between PAM controller 120 and cloud service provider 125 and between cloud service provider 125 and user device 130 may be secure for privacy reasons. As such, cloud service provider 125 may perform certain functionality, such as, for example, verifying data integrity, performing virus scans, scanning for malware, comparing security hashes, verifying sources, verifying digital signatures, ensuring database integrity, billing, collections, authenticating users, verifying user contact information, etc. In some embodiments, for example, access and communications between PAM controller 120 and cloud service provider 125 and between cloud service provider 125 and user device 130 may be accommodated over an established secure communication link, such as, for example, a secure tunnel (e.g., SSL) setup.

In some embodiments, cloud service provider 125 may also be configured to manage the tracking of tagged objects. That is, cloud service provider 125 may determine the differences in location between previously reported tag location-related information and recent or current reported tag location information, thereby indicating that the object has moved from one zone location to another within personal area 150. Cloud service provider 125 may then determine the differences in location information and provide a “movement” alert message to user device 130 notifying the user that an object has moved during a certain time interval.

Cloud service provider 125 may be further configured to provide “reminder” alert messages notifying the user that a tagged object should be moved or retrieved by the user within a predetermined time interval as well as provide “forgotten” alert messages notifying the user that a tagged object was not moved or retrieved after the lapsing of a predetermined time limit.

The various examples, features, and aspects of the disclosed embodiments thus provide a personalized area mapping system capable of storing, tracking, managing, and displaying personal objects, either locally or remotely. It will be appreciated that such a system provides a flexible, easily installed, and low-cost solution without reliance on complex infrastructures.

Having thus described the basic concepts, it will be rather apparent to those skilled in the art after reading this detailed disclosure that the foregoing detailed disclosure is intended to be presented by way of example only and is not limiting. Various alterations, improvements, and modifications will occur and are intended to those skilled in the art, though not expressly stated herein. These alterations, improvements, and modifications are intended to be suggested by this disclosure, and are within the spirit and scope of the exemplary aspects of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure. In addition, the term “logic” is representative of hardware, firmware, software (or any combination thereof) to perform one or more functions. For instance, examples of “hardware” include, but are not limited to, an integrated circuit, a finite state machine, or even combinatorial logic. The integrated circuit may take the form of a processor such as a microprocessor, an application specific integrated circuit, a digital signal processor, a micro-controller, or the like.

Furthermore, the recited order of method, processing elements, or sequences, or the use of numbers, letters, or other designations therefore, is not intended to limit the claimed processes and methods to any order except as can be specified in the claims. Although the above disclosure discusses through various examples what is currently considered to be a variety of useful aspects of the disclosure, it is to be understood that such detail is solely for that purpose, and that the appended claims are not limited to the disclosed aspects, but, on the contrary, are intended to cover modifications and equivalent arrangements that are within the spirit and scope of the disclosed aspects.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claimed subject matter requires more features than are expressly recited in each claim. Rather, as the following claims reflect, inventive aspects lie in less than all features of a single foregoing disclosed embodiment. Thus, the claims following the detailed description are hereby expressly incorporated into this detailed description.

What is claimed is:

1. A system comprising:
a plurality of wireless tag elements, each tag element having unique first identifier information and configured to be attached to an object that is to have its location tracked;
a plurality of wireless sensors physically arranged to provide corresponding zones of coverage that collectively define an area mapping the location of the objects to be tracked, each of the wireless sensors having unique second identifier information and configured to:
wirelessly transmit a scanning signal that detects presence of at least one of the wireless tag elements,
read the first identifier information corresponding to the detected wireless tag elements, based on the wireless scanning signal, and
wirelessly transmit the first identifier information along with its second identifier information; and
a controller configured to wirelessly communicate with the wireless sensors, the controller receiving the first identifier information of the detected tag elements and the second identifier information of the wireless sensors; and
logic configured to:
correlate the second identifier information with first identifier information to determine which zones of coverage each of the detected tag elements are located, and
provide area mapping information indicating the location of the objects based on the location of the detected tag elements within the zones of coverage.

2. The system of claim 1, wherein each of the wireless tag elements includes an antenna, circuitry for receiving and processing the wireless scanning signal, and nonvolatile memory for storing the first identifier information.

3. The system of claim 1, wherein each of the wireless sensors includes an antenna, circuitry for receiving/transmitting the wireless scanning signal, for transmitting/receiving wireless signals to/from the controller, and for processing the first identifier information, and nonvolatile memory for storing the second identifier information.

4. The system of claim 1, wherein the controller further comprises a microprocessor, memory controller, memory, and a secure memory unit integrated on a system-on-chip (SoC) module.

5. The system of claim 4, wherein the secure memory unit comprises a trusted platform module (TPM).

6. The system of claim 1, wherein each of the wireless sensors transmits the wireless scanning signal on a periodic basis.

7. The system of claim 1, wherein the controller wirelessly transmits instructions to each of the wireless sensors to initiate transmission of the wireless scanning signal.

8. The system of claim 1, wherein the wireless sensors communicate with wireless tag elements in accordance with one or more of the following communication specifications/protocols: Bluetooth low energy, low power WiFi, Zigbee, Z-Wave, and RFID.

9. The system of claim 1, wherein the wireless sensors communicate with the controller in accordance with one or more of the following specifications/protocols: Bluetooth low energy, low power WiFi, Zigbee, Z-Wave, and RFID.

10. The system of claim 1, wherein the controller is configured to wirelessly transmit the area mapping information to a user device.

11. The system of claim 10, wherein the controller communicates with the user device in accordance with one or more of the following communication specifications/protocols: Bluetooth, Bluetooth low energy, WiFi, low power WiFi, Zigbee, Z-Wave, RFID, Wi-Gi, GSM, CDMA, GPRS, 3G, 4G, WiMAX, LTE, Wireless USB, and satellite communications.

12. The system of claim 5, wherein access to the mapping information is protected by security information stored in the TPM module.

13. The system of claim 1, wherein the controller is configured to transmit the area mapping information to a third party service provider.

14. The system of claim 15, wherein the controller communicates with the third party service provider in accordance with one or more of the following communication specifications/protocols: Ethernet, Bluetooth, Bluetooth low energy, WiFi, low power WiFi, Zigbee, Z-Wave, RFID, Wi-Gi, GSM, CDMA, GPRS, 3G, 4G, WiMAX, LTE, Wireless USB, and satellite communications.

15. The system of claim 13, wherein access to the mapping information is protected by security information stored in the TPM module.

16. The system of claim 13, wherein access to the mapping information is protected by establishing a secure SSL communication link between the controller and the third party service provider.

17. The system of claim 1, wherein the logic is further configured to provide the area mapping information in a graphical display indicating the location of the objects based on representations of the zones of coverage.

18. The system of claim 1, wherein the logic is further configured to provide an alert message notifying that a predetermined object with a tagged element is to be moved within a preselected period of time.

19. The system of claim 1, wherein the logic is further configured to an provide alert message notifying that a predetermined object with a tagged element has not been moved to a pre-designated zone after lapsing of a preselected period of time.

20. The system of claim 1, wherein the logic is further configured to determine movement of a predetermined object with a tagged element by comparing the location of the detected tag elements between two instances in time and to provide an alert message notifying that the predetermined object has moved from one location to another within the zones of coverage.

21. The system of claim 1, wherein the controller comprises a portable electronic device.

22. The system of claim 1, wherein each of the wireless tag elements comprise one or more of the following: a sticker, bracelet, wristband, label, card, printed stamp, key fob, and pin.

23. The system of claim 10, wherein the user device comprises a portable electronic device.

24. An apparatus, comprising:
a controller configured to:
receive first identifier information indicative of detected tag elements individually attached to objects to be tracked, the first identifier information being unique to each of the tag elements, and
receive second identifier information indicative of wireless sensors that wirelessly detect the tag elements, the second identifier information being unique to each of the wireless sensors, the wireless sensors physically arranged to provide corresponding zones of coverage that collectively define an area mapping the location of the objects to be tracked; and
logic configured to:
correlate the received second identifier information with received first identifier information to determine which zones of coverage each of the detected tag elements are located, and
provide area mapping information indicating the location of the objects based on the location of the detected tag elements within the zones of coverage.

25. The apparatus of claim 24, wherein the controller further comprises a microprocessor, memory controller, memory, and a secure memory unit integrated on a system-on-chip (SoC) module.

26. The apparatus of claim 25, wherein the secure memory unit comprises a trusted platform module (TPM).

27. The apparatus of claim 24, wherein the controller wirelessly transmits instructions to each of the wireless sensors to initiate scanning operations to detect the tag elements.

28. The apparatus of claim 24, wherein the wireless sensors communicate with wireless tag elements in accordance with one or more of the following communication specifications/protocols: Bluetooth low energy, low power WiFi, Zigbee, Z-Wave, and RFID.

29. The apparatus of claim 24, wherein the wireless sensors communicate with the controller in accordance with one or more of the following specifications/protocols: Bluetooth low energy, low power WiFi, Zigbee, Z-Wave, and RFID.

30. The apparatus of claim 24, wherein the controller is configured to wirelessly transmit the area mapping information to a user device.

31. The apparatus of claim 30, wherein the controller communicates with the user device in accordance with one or more of the following communication specifications/protocols: Bluetooth, Bluetooth low energy, WiFi, low power WiFi, Zigbee, Z-Wave, RFID, Wi-Gi, GSM, CDMA, GPRS, 3G, 4G, WiMAX, LTE, Wireless USB, and satellite communications.

32. The apparatus of claim 26, wherein access to the mapping information is protected by security information stored in the TPM module.

33. The apparatus of claim 24, wherein the controller is configured to transmit the area mapping information to a third party service provider.

34. The apparatus of claim 33, wherein the controller communicates with the third party service provider in accordance with one or more of the following communication specifications/protocols: Ethernet, Bluetooth, Bluetooth low energy, WiFi, low power WiFi, Zigbee, Z-Wave, RFID, Wi-Gi, GSM, CDMA, GPRS, 3G, 4G, WiMAX, LTE, Wireless USB, and satellite communications.

35. The apparatus of claim 33, wherein access to the mapping information is protected by security information stored in the TPM module.

36. The apparatus of claim 33, wherein access to the mapping information is protected by establishing a secure SSL communication link between the controller and the third party service provider.

37. The apparatus of claim 24, wherein the logic is further configured to provide the area mapping information in a graphical display indicating the location of the objects based on representations of the zones of coverage.

38. The apparatus of claim 24, wherein the logic is further configured to provide an alert message notifying that a predetermined object with a tagged element is to be moved within a preselected period of time.

39. The apparatus of claim 1, wherein the logic is further configured to an provide alert message notifying that a predetermined object with a tagged element has not been moved to a pre-designated zone after lapsing of a preselected period of time.

40. The apparatus of claim 1, wherein the logic is further configured to determine movement of a predetermined object with a tagged element by comparing the location of the detected tag elements between two instances in time and to provide an alert message notifying that the predetermined object has moved from one location to another within the zones of coverage.

41. The apparatus of claim 24, comprising a portable electronic device.

42. The apparatus of claim 24, wherein each of the wireless tag elements comprise one or more of the following: a sticker, bracelet, wristband, label, card, printed stamp, key fob, and pin.

43. The apparatus of claim 30, wherein the user device comprises a portable electronic device.
